(19) United States
(12) Patent Application Publication
(10) Pub. No.: US 2008/0101787 A1
(43) Pub. Date: May 1, 2008

(54) Multipurpose image pickup device

(75) Inventor: Claire Lee Jung Kuo, Taipei City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: TOP EIGHT INDUSTRIAL CORP.

(21) Appl. No.: 11/652,664

(22) Filed: Jan. 12, 2007

(30) Foreign Application Priority Data
Oct. 31, 2006 (CN) 200620137500.0

(51) Int. Cl. G03B 17/00

(52) U.S. Cl. 396/310

(57) ABSTRACT

A multipurpose image pickup device is disclosed to include a housing having a built-in storage battery and a memory card slot for receiving a memory card for storing digital image files, a swivel bracket turnable in and out of a top recess of the housing, a movable rack turnable in and out of an opening of the swivel bracket, a lens holder pivoted to the movable rack and holding an image forming lens for taking pictures, a lock release for locking/unlocking the swivel bracket and the movable rack, and a mode selection switch switching between a computer connection mode for enabling the multipurpose image pickup device to be used as a webcam and a business card shooting mode for enabling the multipurpose image pickup device to be independently used to take the pictures of business cards.

### BACKGROUND OF THE INVENTION

1. Field of the Invention

The present invention relates generally to an image pickup device and more particularly, to a multipurpose image pickup device that can be used as a webcam for connection to the internet, a business card camera for taking photos of business cards, as well as a card reader for reading data from a card.

2. Description of the Related Art

Following fast development of information industry, a variety of internet and mobile communication devices have been disclosed and have appeared on the market. Many people intensively use these internet and mobile communication devices daily. For example, when a webcam is connected to a computer, it uploads images to the web server. Further, there are commercial business card scanners for scanning the images of business cards for further business card recognition, search, and management.

A webcam and a business card scanner are two different items for different purposes. Taiwan Patent Publication No. M289565 discloses a combination device, entitled “Business card picture shot and webcam combination structure” that combines the function of a webcam and the function of a business card scanner. This design comprises a base frame, a retractable frame coupled to the base frame, and a sliding support coupled to the retractable frame to support an image pickup device. This structure is folding collapsible for convenient carrying, and can be positioned on a desk for use as a webcam, or set for taking the picture of a business card for enabling the business card image file thus obtained to be stored in the computer for further recognition and search. However, this structure must be used with a computer to achieve the two webcam and business card picture shooting functions.

### SUMMARY OF THE INVENTION

The present invention has been accomplished under the circumstances in view. It is therefore the main object of the present invention to provide a multipurpose image pickup device that can be used as a webcam, a business card camera, as well as a card reader. When the multipurpose image pickup device is not connected to a computer, it can be used independently to take the pictures of business cards and to store the digital image files thus obtained in a memory card.

To achieve this and other objects of the present invention, the multipurpose image pickup device comprises a housing, the housing having a circuit board built therein, a top recess in a top side thereof, a mode selection switch electrically connected to the circuit board and switching between a computer connection mode and a business card picture shooting mode, at least one memory card slot electrically connected to the circuit board for receiving a memory card, a shutter release electrically connected to the circuit board, a communication port electrically connected to the circuit board for connection to a computer, a battery electrically connected to the circuit board; a swivel bracket receivable in the top recess of the housing, the swivel bracket having a bottom end pivoted to one end of the top recess of the housing by hinge means, a top end, and an opening between the bottom end and top end of the swivel bracket; a movable rack receivable in the opening of the swivel bracket, the movable rack having a bottom end pivoted to one end of the opening of the swivel bracket by hinge means and a top end opposite to the bottom end of the movable rack; a lens holder receivable with the movable rack in the opening of the swivel bracket, the lens holder having a bottom end pivoted to the top end of the movable rack and holding an image forming lens that is electrically connected to the circuit board and the shutter release for taking pictures for enabling the image data thus obtained to be stored in the memory card that is inserted into the memory card slot; and a lock release mounted in the housing and adapted to lock the lens holder and the movable racket to the swivel bracket and to lock the swivel bracket to the housing.

Further, the housing has a power input terminal electrically connected to a charging circuit of the circuit board for charging the battery with an external power source.

Further, the housing has clamp means bilaterally provided at the top side thereof adjacent to the swivel bracket for securing a business card.

Further, the movable rack has a bottom hook hole. The lock release comprises a track fixedly mounted inside the housing, a button suspending outside the housing adjacent to the track, a bevel-edged actuating rod the perpendicularly extended from a bottom side of the button and inserted into the track, a sliding hook slidably mounted in the track and disposed in close contact with the bevel-edged actuating rod for hooking in the bottom hook hole of the movable rack, and a spring member mounted inside the track and connected between one end of the track and one end of the sliding hook.

Further, the hinge means that pivotally connect the swivel bracket to the housing and the movable rack to the swivel bracket each comprise a barrel-like fixed hinge member, which has a mounting portion fastened to the swivel bracket or the movable rack, a torsional spring inserted into the barrel-like fixed hinge member, the torsional spring having a first end affixed connected to the barrel-like fixed hinge member and a second end opposite to the first end, and a movable hinge member, which has a connecting rod extended from one end thereof and fastened to the second end of the torsional spring in the barrel-like fixed hinge member and a mounting rod extended from an opposite end thereof and fastened to the housing or the swivel bracket.

### BRIEF DESCRIPTION OF THE DRAWINGS

FIG. 1 is an exploded view of a multipurpose image pickup device according to the present invention.

FIG. 2 is an exploded view of a part of the present invention, showing the structure of the lock release.

FIG. 3 is an exploded view of a part of the present invention, showing the structure of the hinge.

FIG. 4 is an elevational assembly view of the multipurpose image pickup device according to the present invention.

FIG. 5 is a sectional view of the multipurpose image pickup device according to the present invention.

FIG. 6 is a schematic drawing of the present invention, showing the multipurpose image pickup device set for use as a webcam.

FIG. 7 is a schematic drawing of the present invention, showing the multipurpose image pickup device set for business card picture shooting.

### DETAILED DESCRIPTION OF THE INVENTION

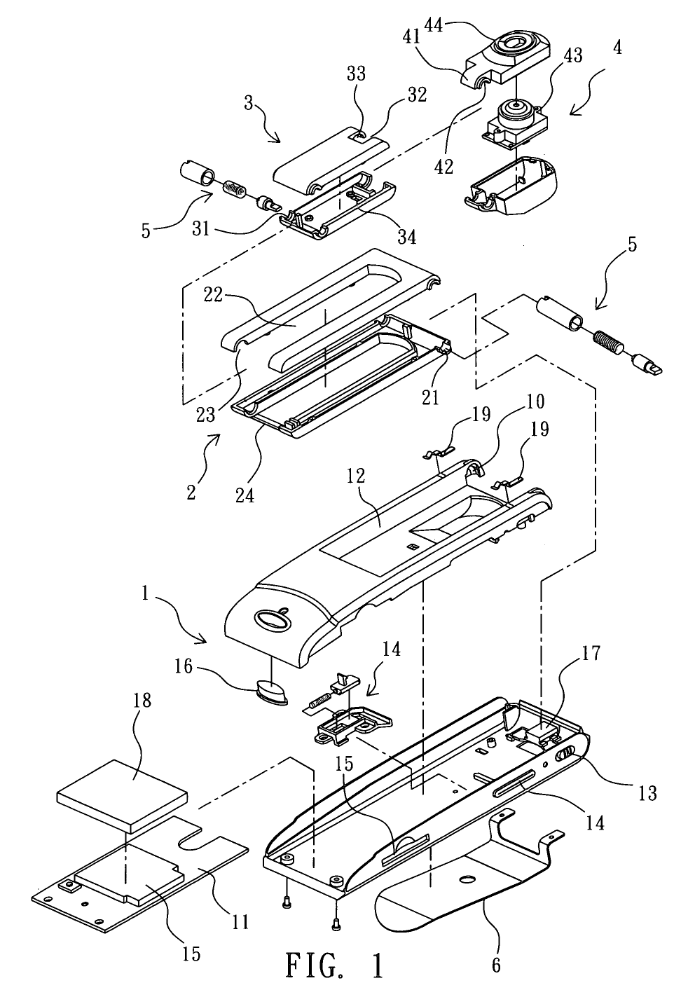

Referring to FIG. 1, a multipurpose image pickup device in accordance with the present invention is shown comprised of a housing 1, a swivel bracket 2, a movable rack 3, and a lens holder 4.

The housing 1 is formed of two narrow elongated cover shells and holding a circuit board 11 on the inside, having a longitudinal top recess 12 on the top wall for accommodating the swivel bracket 2, the movable rack 3 and the lens holder 4. As illustrated, the housing 1 has provided at a suitable location, for example, one lateral side a mode selection switch 13, a lock release 14, and a memory card slot 15. The mode selection switch 13 can be switched between the computer connection mode and the picture shooting mode. When pressed the lock release 14, the swivel bracket 2 or the movable rack 3 is unlocked for free movement. The detailed action of the lock release 14 will be discussed further. The memory card slot 15 is for receiving a memory card, for example, SD card (not shown) for storing every image file obtained through the lens holder 4 under the picture shooting mode. Further, a shutter release 16 is provided at a suitable location of the housing 1, for example, the front side. When the user pressed the shutter release 16, the image forming lens 43 that is mounted inside the lens holder 4 is opened to take a picture. A communication port 17, for example, USB port is provided at the rear side of the housing 1 for connection to a computer.

Further, a battery 18 is built in the housing 1 to provide the necessary working voltage to the image forming lens 43 of the lens holder 4 and the memory card in the memory card slot 15 of the circuit board 11 when the multipurpose image pickup device is in the picture shooting mode and not connected to a computer. The battery 18 is a rechargeable battery. A power input terminal (not shown) is mounted in the housing 1 and electrically connected to a charging circuit of the circuit board 11 for charging the battery 18 with city power supply through a power adapter (not shown).

Further, two clamps 19 are bilaterally provided at the top side of the housing 1 for securing a business card or the like. The housing 1 further has two axle holes 10 bilaterally aligned at one end of the longitudinal top recess 12 for the mounting of the swivel bracket 2.

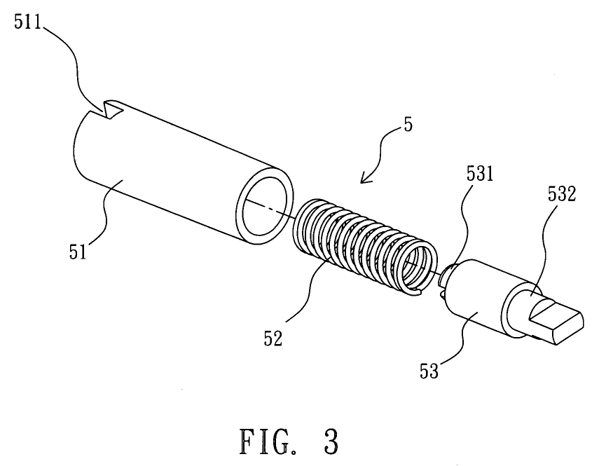

The swivel bracket 2 is an elongated flat frame receivable in the longitudinal top recess 12, having two pins 21 bilaterally and transversely disposed at one end and respectively pivotally coupled to the axle holes 10 of the housing 1 such that the swivel bracket 2 is turnable relative to the housing 1 in and out of the longitudinal top recess 12. Further, in order to provide the function of having the swivel bracket 2 be automatically ejected out of the top recess 12 of the housing 1, a hinge 5 is provided between each pivot pin 21 of the swivel bracket 2 and the corresponding axle hole 10 (see FIG. 3). The structure of the hinge 5 will be discussed further. The swivel bracket 2 has an opening 22 for receiving the movable rack 3 and the lens holder 4. Further, the swivel bracket 2 has two axle holes 23 bilaterally disposed at the top end for the coupling of the movable rack 3, and a transverse stop rod 24 disposed adjacent to the axle holes 23 for stopping the movable rack 3 in the extended position.

The movable rack 3 is an elongated flat frame having a width corresponding to the opening 22 of the swivel bracket 2. Further, the movable rack 3 has two pins 31 bilaterally and transversely disposed at the bottom end and respectively pivotally coupled to the axle holes 23 of the swivel bracket 2 through a respective hinge 5 such that the movable rack 3 is turnable relative to the swivel bracket 2 and can be automatically ejected out of the swivel bracket 2. The movable rack 3 further has a top notch 32 on the top end and two pivot holes 33 at two sides of the top notch 32 for the coupling of the lens holder 4, and a bottom hook hole 34 for receiving the lock release 14 to lock the movable rack 3 in the received position. When the user pressed the lock release 14, the lock release 14 is disengaged from the bottom hook hole 34 to unlock the movable rack 3, enabling the swivel bracket 2 and the movable rack 3 to be respectively ejected out of the longitudinal top recess 12 and the opening 22.

The lens holder 4 has a width approximately equal to the movable rack 3, a bottom bar 41 extended from the bottom end, two pivot pins 42 respectively and transversely extended from the bottom bar 41 at two sides and respectively pivoted to the pivot holes 33 of the movable rack 3, and a lens hole 44 corresponding to the image forming lens 43. When light enters the lens hole 44, the image forming lens 43 picks up the image of the incident light.

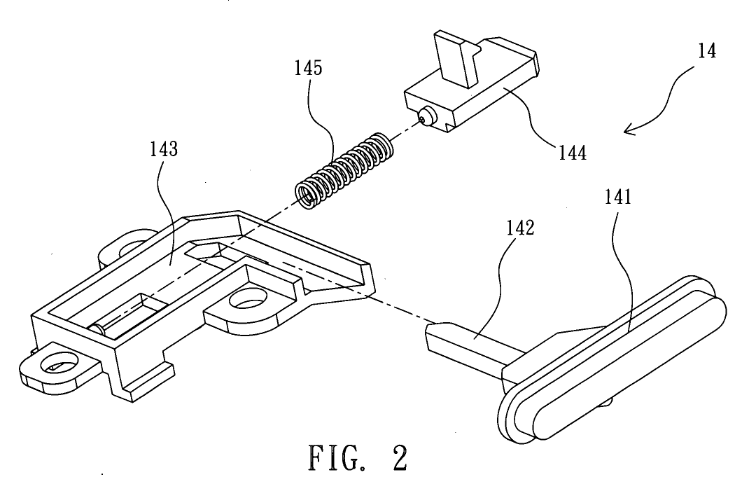

Referring to FIG. 2, the lock release 14 comprises a track 143 fixedly mounted inside the housing 1, a button 141 suspending outside the housing 1 adjacent to the track 143, an actuating rod 142 perpendicularly extended from the bottom side of the button 141 and inserted into the track 143, a sliding hook 144 slidably mounted in the track 143 and disposed in close contact with the beveled free end of the actuating rod 142, and a spring member 145 mounted inside the track 143 and connected between one end of the track 143 and one end of the sliding hook 144. The spring member 145 imparts a pressure to the sliding hook 144, thereby holding the sliding hook 144 in the locking position where the sliding hook 144 is hooked in the bottom hook hole 34 to lock the movable rack 3. When the user pressed the button 141, the actuating rod 142 is forced to move the sliding hook 144 away from the bottom hook hole 34, thereby unlocking the movable rack 3.

Referring to FIG. 3, the hinge 5 comprises a barrel-like fixed hinge member 51, which has a mounting portion 511 fastened to the associating pin 21 of the swivel bracket 2 or the associating pin 31 of the movable rack 3, a torsional spring 52 inserted into the barrel-like fixed hinge member 51 and affixed with its one end to the inside of the barrel-like fixed hinge member 51, and a movable hinge member 53, which has a connecting rod 531 extended from its one end and fastened to the other end of the torsional spring 52 in the barrel-like fixed hinge member 51 and a mounting rod 532 extended from its opposite end and fastened to the associating axle hole 10 of the housing 1 or the associating axle hole 23 of the swivel bracket 2. When the movable rack 3 is received in the opening 22 of the swivel bracket 2 and the swivel bracket 2 is received in the longitudinal top recess 12 of the housing 1, the torsional spring 52 of each hinge 5 is twisted to preserve energy, and at the same time the sliding hook 144 is forced by the spring member 145 into engagement with the bottom hook hole 34 to lock the movable rack 3. When unlocked, the torsional springs 52 of the hinges 5 release energy, thereby forcing the swivel bracket 2 out of the longitudinal top recess 12 of the housing 1 and the movable rack 3 out of the opening 22 of the swivel bracket 2.

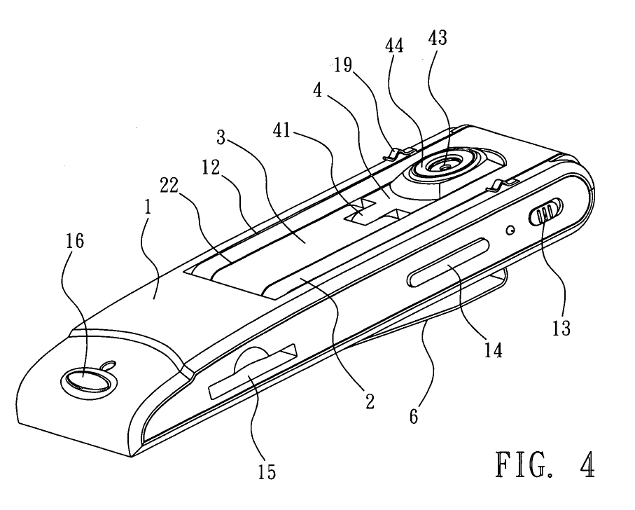

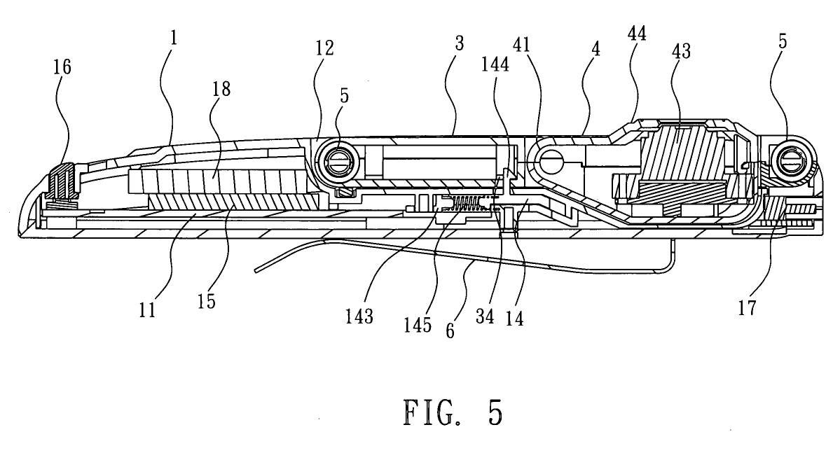

FIG. 4 is an elevational assembly view of the multipurpose image pickup device. FIG. 5 is a sectional view of the multipurpose image pickup device. Further, a clip 6 is provided at the bottom side of the housing 1. By means of the clip 6, the multipurpose image pickup device can be fastened to, for example, the belt on the user's body.

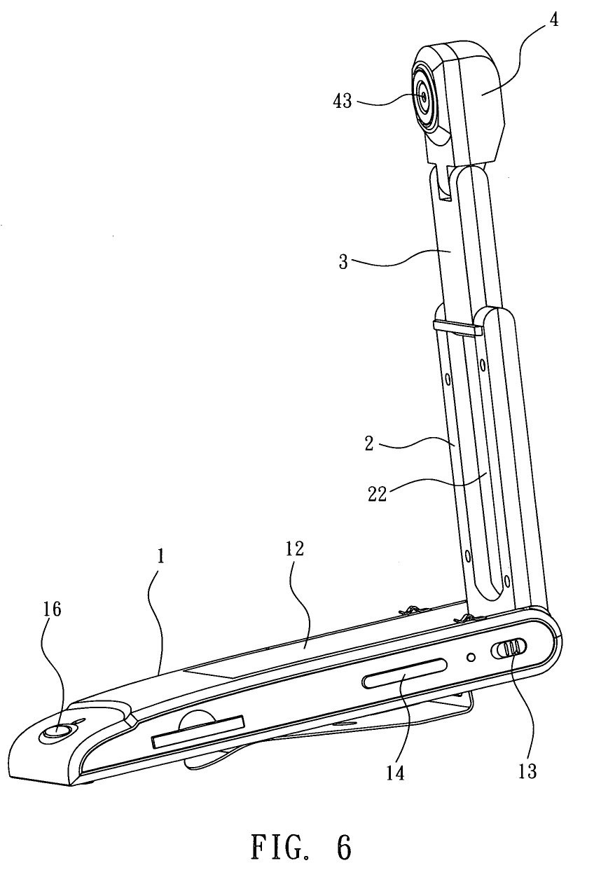

Referring to FIG. 6, the multipurpose image pickup device can be set for use as a webcam. In this case, the communication port 17 is connected to a computer, and the mode selection switch 13 is switched to the computer connection mode. When pressed the lock release 14 at this time, the swivel bracket 2 is extended out of the movable rack 3 and the movable rack 3 is extended out of the housing 1 due to the effect of the associating hinges 5. Thereafter, bias the lens holder 4 relative to the swivel bracket 2 to aim the image forming lens 43 at the user of the computer for computer-to-computer video transmission.

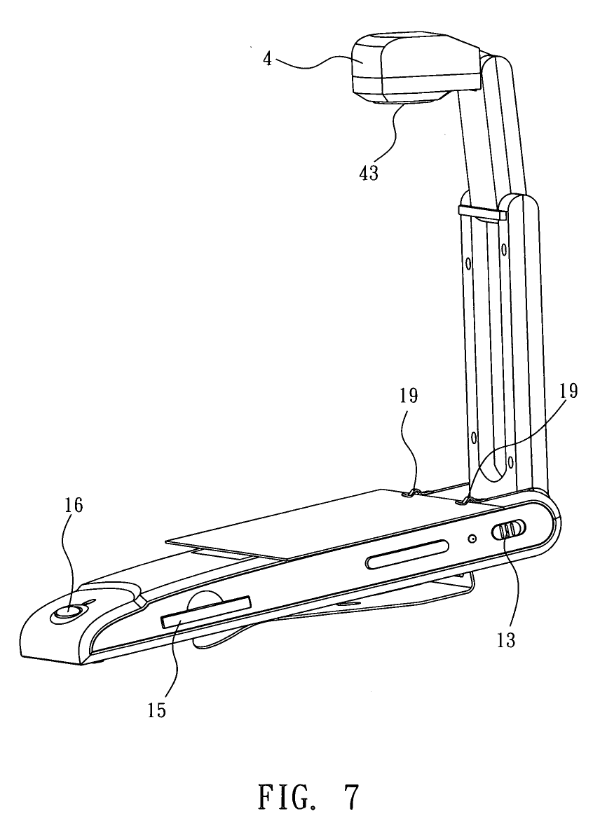

Referring to FIG. 7, when wishing to take the picture of a business card, switch the mode selection switch 13 to the business card picture shooting mode, and then fasten the business card to the top side of the housing 1 by the clamps 19, and then bias the lens holder 4 relative to the swivel bracket 2 to aim the image forming lens 43 at the business card, and then press the shutter release 16 to take the picture of the business card and to have to digital image file thus obtained be stored in the memory card that is inserted into the memory card slot 15. Therefore, when the multipurpose image pickup device is not connected to a computer, for example, when in the outside open field, the built-in battery 18 provides the necessary working voltage, and the user can use the multipurpose image pickup device to take the picture of a business card and store the image file in a memory card.

As indicated above, the invention provides a multipurpose image pickup device that can be used as a webcam, a business card camera, as well as a card reader. Further, the housing, the swivel bracket, the movable rack and the lens holder are pivotally connected to one another. By unlocked, the associating hinges automatically extend the parts one out of another to the operative position. The build-in battery and memory card slot of the housing enhances the mobility characteristic of the multipurpose image pickup device. When not connected to a computer, the multipurpose image pickup device can be independently used for taking the pictures of business cards and storing the digital image files thus obtained. The storage digital image files can be further transmitted to a computer for further recognition and data search.

A prototype of multipurpose image pickup device has been constructed with the features of FIGS. 1˜7. The multipurpose image pickup device functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A multipurpose image pickup device comprising:
a housing, said housing having a circuit board built therein, a top recess in a top side thereof, a mode selection switch electrically connected to said circuit board and switching between a computer connection mode and a business card picture shooting mode, at least one memory card slot electrically connected to said circuit board for receiving a memory card, a shutter release electrically connected to said circuit board, a communication port electrically connected to said circuit board for connection to a computer, a battery electrically connected to said circuit board;
a swivel bracket receivable in said top recess of said housing, said swivel bracket having a bottom end pivoted to one end of said top recess of said housing by hinge means, a top end, and an opening between the bottom end and top end of said swivel bracket;
a movable rack receivable in said opening of said swivel bracket, said movable rack having a bottom end pivoted to one end of said opening of said swivel bracket by hinge means and a top end opposite to the bottom end of said movable rack;
a lens holder receivable with said movable rack in said opening of said swivel bracket, said lens holder having a bottom end pivoted to the top end of said movable rack and holding an image forming lens that is electrically connected to said circuit board and said shutter release for taking pictures for enabling the image data thus obtained to be stored in the memory card that is inserted into said memory card slot; and
a lock release mounted in said housing and adapted to lock said lens holder and said movable rack to said swivel bracket and to lock said swivel bracket to said housing.

2. The multipurpose image pickup device as claimed in claim 1, wherein said housing has a power input terminal electrically connected to a charging circuit of said circuit board for charging said battery with an external power source.

3. The multipurpose image pickup device as claimed in claim 1, wherein said memory card slot is a SD card type memory card slot.

4. The multipurpose image pickup device as claimed in claim 1, wherein said housing has clamp means bilaterally provided at the top side thereof adjacent to said swivel bracket for securing a business card.

5. The multipurpose image pickup device as claimed in claim 1, wherein said swivel bracket has a transverse stop rod disposed at the top end thereof for stopping said movable rack in place when said movable rack is turned out of the opening of said swivel bracket.

6. The multipurpose image pickup device as claimed in claim 1, wherein said movable rack has a bottom hook hole; said lock release comprises a track fixedly mounted inside said housing, a button suspending outside said housing adjacent to said track, a bevel-edged actuating rod said perpendicularly extended from a bottom side of said button and inserted into said track, a sliding hook slidably mounted in said track and disposed in close contact with said bevel-edged actuating rod for hooking in the bottom hook hole of said movable rack, and a spring member mounted inside said track and connected between one end of said track and one end of said sliding hook.

7. The multipurpose image pickup device as claimed in claim 1, wherein the hinge means that pivotally connect said swivel bracket to said housing and said movable rack to said swivel bracket each comprise a barrel-like fixed hinge member, which has a mounting portion fastened to said swivel bracket or said movable rack, a torsional spring inserted into said barrel-like fixed hinge member, said torsional spring having a first end affixed connected to said barrel-like fixed hinge member and a second end opposite to said first end, and a movable hinge member, which has a connecting rod extended from one end thereof and fastened to the second end of said torsional spring in said barrel-like fixed hinge member and a mounting rod extended from an opposite end thereof and fastened to said housing or said swivel bracket.

8. The multipurpose image pickup device as claimed in claim 1, further comprising a clip fixedly provided at a bottom side of said housing for fastening.
